(19) United States
(12) Patent Application Publication
(10) Pub. No.: US 2025/0153248 A1
(43) Pub. Date: May 15, 2025

(54) Additively Manufactured Passive Damping Structures for Metal Cutting

(71) Applicant: Kennametal Inc., Latrobe, PA (US)

(72) Inventors: Dominik Schmid, Fuerth (DE); Johannes Ellinger, Memmingen (DE); Thomas Mair, Hohenwart (DE); Edward Rusnica, Irwin, PA (US); Samuel Eichelberger, Latrobe, PA (US); Werner Hernandez, Latrobe, PA (US)

(21) Appl. No.: 18/508,604

(22) Filed: Nov. 14, 2023

(51) Int. Cl. B23B 29/02; B33Y 80/00

(52) U.S. Cl. CPC B23B 29/022; B33Y 80/00

(57) ABSTRACT

A cutting tool has a tool body with a proximal end for mounting to drive unit and a distal end for engaging a workpiece for cutting. The tool body extends longitudinally along a central axis of the tool body. The tool body defines an interior space therein. One or more additively manufactured passive dampers are disposed in the interior space of the tool body.

### BACKGROUND

This relates in general to damping structures for metal cutting.

When machining workpieces using long and narrow tools, such as boring bars, unwanted vibrations can occur due to the dynamic compliance of the tool.

Several methods to attempt to reduce vibration are known. One method for attempting to reduce vibration includes using a tool fabricated from a relatively stiffer material than standard carbon steel, such as solid carbide (e.g., tungsten carbide). Another method to attempt to reduce vibration in boring bars or other tools includes using a vibration absorber mechanism, such as placement of a cylindrical mass of a high-density material, relative to the boring bar or tool, within the boring bar or tool.

Further, restrictions in the available space during machining and high system costs limit the use of active dampers, which might otherwise be used to mitigate unwanted vibrations.

In currently available damping products, the damping features are separately manufactured components that are assembled with cutting tools after manufacture. This leads to additional costs and limits the reasonable minimum size of the tools equipped with those systems.

Additionally, additive damping structures are known—for example in the form of entrapped powder. However, these structures may have limited damping capability.

For further example, vibration and boring bars are discussed in Analysis of the Vibration Characteristics of a Boring Bar with a Variable Stiffness Dynamic Vibration Absorber (Lie et al. 2019; Hindawi: Shock and Vibration; Volume 2019; Article ID 5284194; 13 pages; https://doi.org/10.1155/2019/5284194)

### SUMMARY

This relates more specifically to cutting tools with additively manufactured passive damping structures.

In one exemplary embodiment, a cutting tool has a tool body with a proximal end for mounting to drive unit and a distal end for engaging a workpiece for cutting. The tool body extends longitudinally along a central axis of the tool body. The tool body defines an interior space therein. One or more additively manufactured passive dampers are disposed in the interior space of the tool body.

In one exemplary embodiment, the cutting tool has a generally cylindrical elongate tool body.

In one exemplary embodiment, the distal end is formed for attachment to a cutting element.

In one exemplary method, additively manufactured structures are integrated into a cutting tool by directly manufacturing the structures with the main tool body. This may include relatively complex structures. The structures are preferably of the same material as the main tool body, such as steel or tungsten carbide; or may be of different material, such as concrete, ceramic, or other material for additive manufacture.

In at least one embodiment, the tool body and the one or more dampers are formed as a unitary body with the tool body and the one or more dampers formed from the same material.

In at least one embodiment, the tool body and the one or more dampers are formed as a unitary body with the tool body and the one or more dampers formed from different materials.

In at least one embodiment, the one or more dampers includes a plurality of lamella layers extending longitudinally within the interior space. The lamella layers preferably have an overall surface length greater than the linear end-to-end length.

In at least one embodiment, the lamella layers are undulated forming waves.

In at least one embodiment, the lamella layers of the plurality of lamella layers are spaced apart from one another.

In at least one embodiment, there is loose powder disposed in the space between the lamella layers.

In at least one embodiment, the lamella layers are under pressure from the powder disposed there between.

In at least one embodiment, the one or more dampers includes one or more spring-mass dampers integrated in the interior space of the tool body.

In at least one embodiment, the spring-mass dampers are in the form of a main damper body with a generally cylindrical stud extending in the longitudinal direction of the tool body, and there is dampening fluid disposed in the interior space about the dampers.

In at least one embodiment the dampening fluid is liquid, and optionally there may also be gas disposed in the interior space.

In at least one embodiment, the spring-mass dampers each include an internal grid at least partially filled with dampening fluid.

In at least one embodiment, the one or more dampers includes spring-mass dampers of varying size such that they have differing values relative to the eigenfrequency of the tool body.

In at least one embodiment, the one or more dampers includes one or more viscoelastic energy-dissipating dampers.

In at least one embodiment, the one or more viscoelastic energy-dissipating dampers forms a honeycomb structure with each of the dampers forming a cell of the honeycomb structure.

In at least one embodiment, each of the dampers is an energy dissipation node including a plurality of radially extending studs. In at least one optional embodiment, the studs are each connected to a cavity wall of the cell in the main body and extend freely to a central area within the cell.

In at least one embodiment, a polymer material is disposed within the cell.

In at least one embodiment, the one or more dampers is formed from a polymer material.

Various aspects will become apparent to those skilled in the art from the following detailed description and the accompanying drawings.

### BRIEF DESCRIPTION OF THE DRAWINGS

FIG. 1A is a is a top side perspective view of a tool assembly.

FIG. 1B is a is a partial top side semi-transparent perspective view of the tool assembly of FIG. 1A showing surface friction dampers.

FIG. 1C is a partial side perspective cross-sectional view of the tool assembly of FIG. 1B with the surface friction dampers semi-transparent.

FIG. 1D is a view similar to FIG. 1C with the tool body partially in phantom and with the surface friction dampers shown opaquely.

FIG. 1E is a partial enlarged side view of a tool assembly similar to the tool assembly of FIG. 1D.

FIG. 1F is a schematic side cutaway view of the tool assembly of FIGS. 1A-1E during operation.

FIG. 2A is a side schematic representation of a tool assembly with viscous dampers.

FIG. 2B is a partial side perspective cross-sectional view of a tool assembly similar to the tool assembly of FIG. 2A.

FIG. 2C is an enlarged side cross-sectional view of one of the viscous dampers of FIG. 2B.

FIG. 2D is a bottom side perspective cutaway view of a viscous damper similar to the viscous damper in FIG. 2C.

FIG. 2E is a close-up cutaway view of the internal structure of a viscous damper similar to the viscous damper of FIG. 2d.

FIG. 2F is a graph representing size to mass to frequency of an exemplary viscous damper.

FIG. 3A is a side schematic representation of a tool assembly with viscoelastic dampers.

FIG. 3B is a side perspective cross-sectional view of a tool assembly similar to the tool assembly of FIG. 2A.

FIG. 3C is a side cross-sectional view of the tool assembly of FIG. 2B.

FIG. 3D is an enlarged view of a portion of FIG. 3C.

FIG. 3E is a side semi-transparent perspective view of a viscoelastic damper similar to the viscoelastic dampers of FIG. 3D.

FIG. 3F is a schematic representation of a viscoelastic damper similar to the viscoelastic damper of FIG. 3E with a radial force to be applied.

FIG. 3G is a view similar to FIG. 3E but with the viscoelastic damper under the load of the applied radial force.

FIG. 3H is a view similar to FIG. 3E but with shear forces to be applied.

FIG. 3I is a view similar to FIG. 3E but with the viscoelastic damper under the load of the applied shear forces.

### DETAILED DESCRIPTION

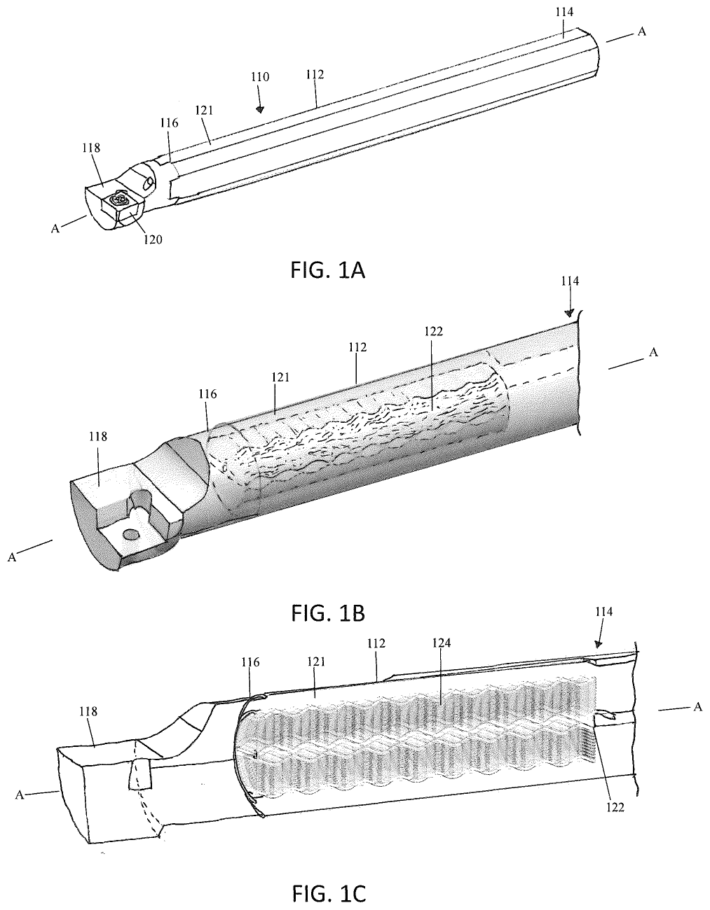

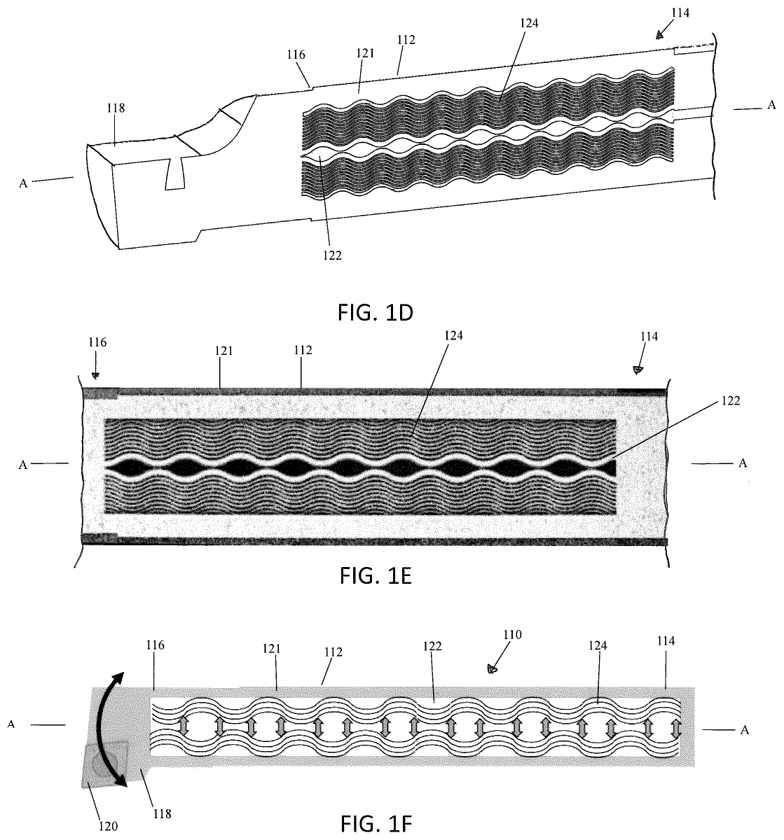

Referring now to the drawings, there is illustrated in FIGS. 1A-1F a tool assembly 110 for a cutting tool operation, also referred to collectively as a cutting tool. In the illustrated embodiment, the cutting tool 110 includes a generally cylindrical elongate tool body 112, e.g. a boring bar. Although, it must be understood that the cutting tool 110 need not be a boring bar and may be other types of cutting tools with a boring bar being used a one exemplary embodiment. The cutting tool 110 has a proximal end 114 for connection to a drive unit and a distal end 116 for engaging a workpiece for cutting. As illustrated, the distal end has a connection to a tool head or tool insert holder 118. A cutting element or tool insert 120 is disposed on the tool head 118. The tool head 118 is adapted to receive the cutting element 120 and is attached to the distal end 116 of the tool body 112. Although, in other embodiments, cutting elements or cutting edges may be formed in the tool body 112 or otherwise connected to the tool body 112.

The tool body 112 includes an outer main body 121 that defines an interior space 122 therein the tool body 112 that extends longitudinally along a central axis A of the tool body 112 from the proximal end 114 to the distal end 116.

One or more additively manufactured passive dampers 124 are disposed in the interior space 122 of the outer main body 121. In one exemplary method of manufacture, additively manufactured passive dampers 124 are integrated into the outer main body 121 by directly manufacturing the dampers 112 with the outer main body 121. In such a case, the dampers 124 are preferably of the same material as the outer main body 121, such as steel or tungsten carbide, although such is not required. The dampers 124 and the outer main body 121 may be of different materials, also including concrete, ceramic, or other material for additive manufacture.

In the illustrated embodiment, the dampers 124 are surface friction dampers in the form of lamella layers extending longitudinally within the interior space 122 and spaced apart from one another. The lamella layers preferably have an overall surface length greater than their linear end-to-end length. The lamella layers are shown as undulated forming waves, although such is not required. Optionally, loose powder may be disposed in the space between the lamella layers. The lamella layers may be under pressure from the powder disposed there between.

The additively manufactured passive dampers 124 may be integrated into the cutting tool 110 by being directly manufactured with/within the outer main body 121. Thus, the dampers 124 may include relatively complex structural designs as they are manufactured in place.

Thus, in at least one embodiment, the outer main body 121 and the one or more dampers 124 are formed as a unitary tool body 112. Although, such is not required. The outer main body 121 and the dampers 124 may be formed separately and joined to form the tool body 112. In either case, the outer main body 121 and the one or more dampers 124 may be formed from the same material or formed from different materials.

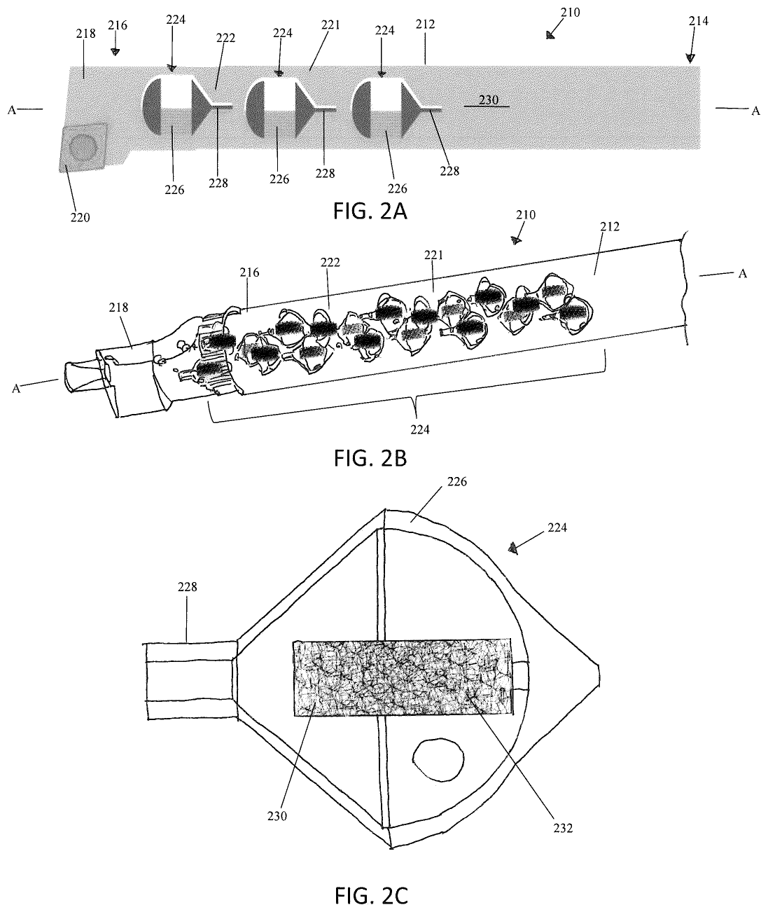

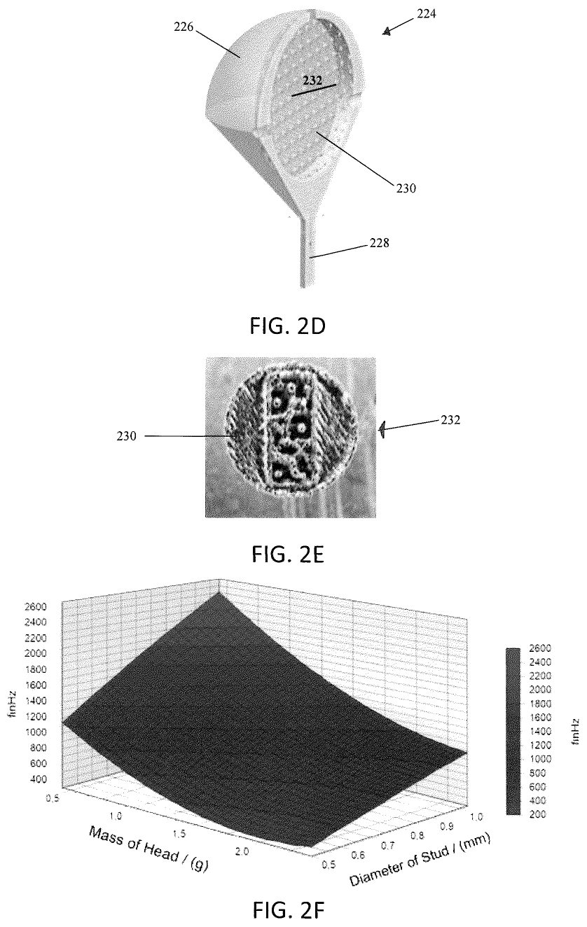

There is illustrated in FIGS. 2A-2E a tool assembly 210 of another embodiment. Similar items as to the cutting tool 110 above have been identified with similar numbers.

The tool assembly 210 includes one or more spring-mass dampers 224 that are integrated into the interior space 222 of the tool body 212. As illustrated, the spring-mass dampers 224 are in the form of a main damper body 226 with a generally cylindrical stud 228 extending in the longitudinal direction of the tool body 212. There is dampening fluid, such as oil, 230 disposed in the interior space 222 about the dampers 224. In at least one embodiment the dampening fluid 230 a liquid, and optionally there may also be a gas disposed in the interior space 222.

In at least one embodiment, the spring-mass dampers 224 each include an optional internal grid or mesh 232 at least partially filled with the dampening fluid 230.

In at least one embodiment, it is contemplated that the one or more dampers 224 may include spring-mass dampers 224 of varying size such that they have differing values relative to the eigenfrequency of the tool body 212.

There is shown in FIG. 2F a graph representing size to mass to frequency of various exemplary viscous dampers 224.

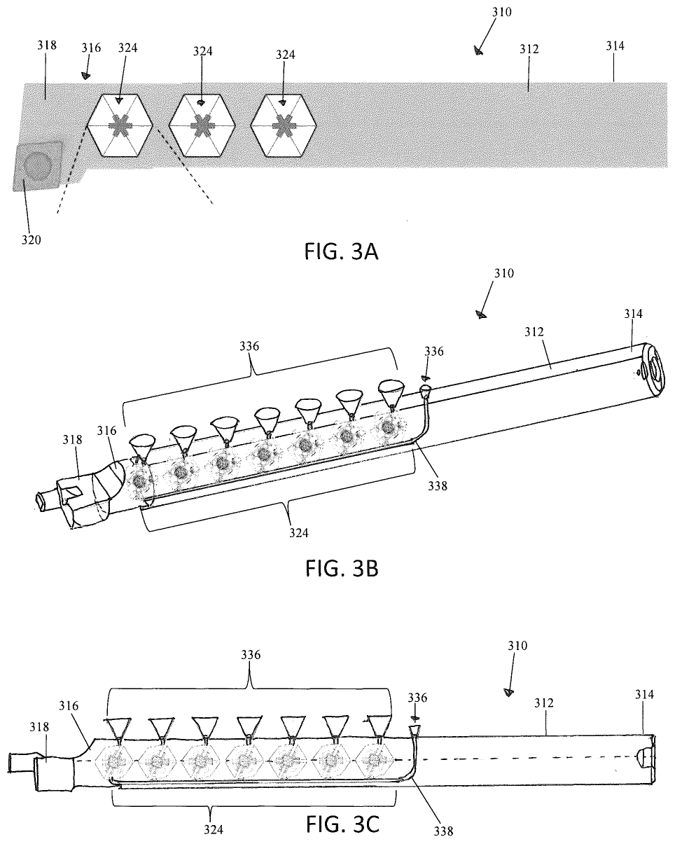

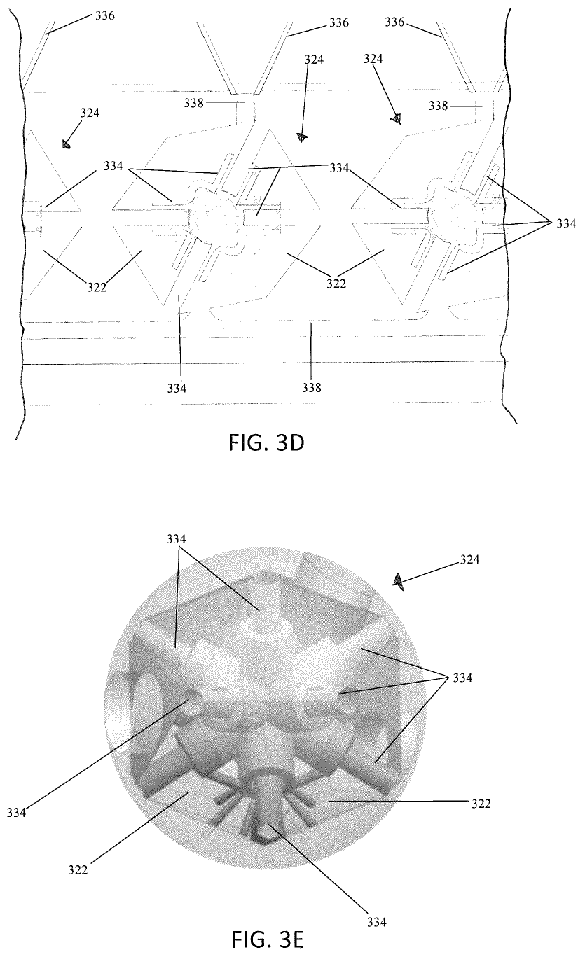

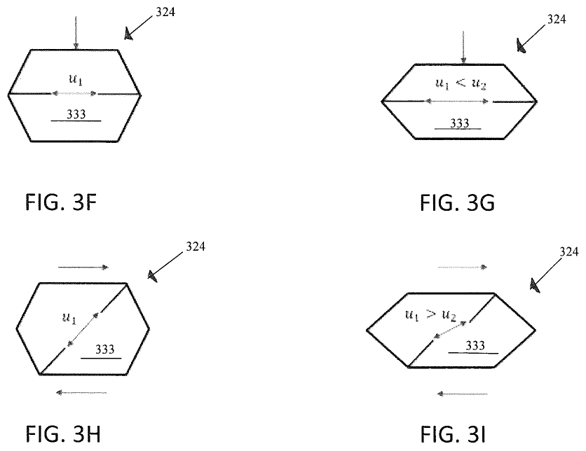

There is illustrated in FIGS. 3A-3E a tool assembly 310 of another embodiment. Similar items as to the cutting tools 110 and 210 above have been identified with similar numbers.

The tool assembly 310 includes one or more viscoelastic energy-dissipating dampers 324. In the illustrated embodiment, the one or more viscoelastic energy-dissipating dampers 324 forms a honeycomb structure with each of the dampers forming a cell of the honeycomb structure, although such is not required. In at least this embodiment, each of the dampers 324 is an energy dissipation node 333 (see FIGS. 3F-3I) including a plurality of radially extending studs 334. In at least one optional embodiment, the studs 334 are each connected to a cavity wall of the cell in the main body 312 and extend freely to a central area within the cell.

In at least one embodiment, the one or more dampers 334 is formed from a polymer material. In at least one embodiment, a polymer material is disposed within the cell and at least partially surrounds the studs 334. There is shown in FIGS. 3B-3D a plurality of cones 336 and passageways 338 to facilitate the introduction of the polymer material to the otherwise formed main body 312. It is noted that the interior space 322 may be fully or partially filled with the added polymer material. It is believed that it is most desired to have at least some polymer material at the central area within the cell.

FIG. 3F shows the viscoelastic damper 324 with a radial force to be applied, and FIG. 3G shows the viscoelastic damper 324 under the load of the applied radial force.

FIG. 3H shows the viscoelastic damper 324 with shear forces to be applied, and FIG. 3I shows the viscoelastic damper 324 under the load of the applied shear forces.

It must be understood that the tool assemblies 110, 210, 310 may include additional features, for example passageways for the conveyance of coolant or lubrication fluid. In such cases, the passageways may be disposed in the interior of the tool body 112, 212, 312 so long as not to interfere with the dampers 124, 224, 324. Alternatively, such passageways may be formed closer to the exterior of the tool body 112, 212, 312, formed in the outer main body 121, 221, 321 away from the dampers 124, 224, 324.

While principles and modes of operation have been explained and illustrated with regard to particular embodiments, it must be understood, however, that this may be practiced otherwise than as specifically explained and illustrated without departing from its spirit or scope.

What is claimed is:

1. A cutting tool comprising:
a tool body having a proximal end for mounting to a drive unit and a distal end for engaging a workpiece for cutting, with the tool body extending longitudinally along a central axis of the tool body and defining an interior space therein; and
one or more additively manufactured passive dampers disposed in the interior space of the tool body.

2. The cutting tool of claim 1 where the tool body and the one or more dampers are formed as a unitary body.

3. The cutting tool of claim 2 where the tool body and the one or more dampers are formed from the same material.

4. The cutting tool of claim 2 where the tool body and the one or more dampers are formed from different materials.

5. The cutting tool of claim 1 where the one or more dampers includes a plurality of lamella layers extending longitudinally within the interior space.

6. The cutting tool of claim 1 where the tool body is a cylindrical elongate tool body.

7. The cutting tool of claim 1 where the distal end is formed for attachment to a cutting element.

8. The cutting tool of claim 5 where there is loose powder disposed in the space between the lamella layers.

9. The cutting tool of claim 8 where the lamella layers and the powder disposed there between are under pressure.

10. The cutting tool of claim 6 where the lamella layers are a complex three-dimensional waveform.

11. The cutting tool of claim 1 where the one or more dampers includes one or more spring-mass dampers integrated in the interior space of the tool body.

12. The cutting tool of claim 11 where the spring-mass dampers are in the form of a main damper body with a generally cylindrical stud extending in the longitudinal direction of the tool body, and there is dampening fluid disposed in the interior space about the dampers.

13. The cutting tool of claim 11 where the spring-mass dampers each include an internal grid.

14. The cutting tool of claim 13 where each internal grid is at least partially filled with at least two dampening fluids, where one dampening fluid is a liquid disposed in the internal grid, and where the other dampening fluid is a gas is also disposed in the internal grid.

15. The cutting tool of claim 11 where the one or more dampers includes spring-mass dampers of varying size such that they have differing values relative to the eigenfrequency of the tool body.

16. The cutting tool of claim 1 where the one or more dampers includes one or more viscoelastic energy-dissipating dampers.

17. The cutting tool of claim 16 where the one or more viscoelastic energy-dissipating dampers forms a honeycomb structure with each of the dampers forming a cell of the honeycomb structure.

18. The cutting tool of claim 16 where each of the dampers is an energy dissipation node including a plurality of radially extending studs.

19. The cutting tool of claim 18 where the studs are each connected to a cavity wall of the cell in the main body and extend freely to a central area within the cell.

20. The cutting tool of claim 18 where the one or more dampers is formed from a combination of the same material as the tool body and a viscous or viscoelastic material.
